(19) United States
(12) Patent Application Publication
(10) Pub. No.: US 2026/0044268 A1
(43) Pub. Date: Feb. 12, 2026

(54) DATA PROTECTION METHOD AND STORAGE DEVICE

(71) Applicant: Hosin Global Electronics Co., LTD, Shenzhen (CN)

(72) Inventors: Hao Wang, Shenzhen (CN); Tsung-Lin Wu, Hsinchu City (TW); Chao-Yu Chen, Shenzhen (CN); Wei Wang, Shenzhen (CN); Qi Ming Zhu, Shenzhen (CN); Xiao Min Chen, Shenzhen (CN); Jing Wan, Shenzhen (CN); Yuan Hong Ye, Shenzhen (CN); Hai Liang Wu, Shenzhen (CN); Kai Qiang Meng, Shenzhen (CN)

(73) Assignee: Hosin Global Electronics Co., LTD, Shenzhen (CN)

(21) Appl. No.: 19/064,515

(22) Filed: Feb. 26, 2025

(30) Foreign Application Priority Data
Aug. 6, 2024 (CN) 202411067899.9

(51) Int. Cl. G06F 3/06

(52) U.S. Cl. CPC G06F 3/0622; G06F 3/0655; G06F 3/0679

(57) ABSTRACT

A data protection method and a storage device are provided. The method includes: reading a first data frame from a first physical unit; executing first type decoding operation on the first data frame; if the first type decoding operation fails, determining whether group data complies with a preset condition, where the group data includes the first data frame and a second data frame read from a second physical unit; if the group data complies with the preset condition, executing second type decoding operation on the group data; if the group data does not comply with the preset condition, dividing the first data frame into multiple first sub-data segments and dividing the second data frame into multiple second sub-data segments, and executing third type decoding operation based on the first sub-data segments and the second sub-data segments. Thereby, the data protection capability of the storage device may be improved.

### CROSS-REFERENCE TO RELATED APPLICATION

This application claims the priority benefit of China application serial no. 202411067899.9, filed on Aug. 6, 2024. The entirety of the above-mentioned patent application is hereby incorporated by reference herein and made a part of this specification.

### BACKGROUND

### Technical Field

The disclosure relates to a field of storage technology, and in particular to a data protection method and a storage device.

### Description of Related Art

With the increasing data storage density of storage devices, the probability of errors occurring when reading data stored in storage devices has also significantly increased. Therefore, some types of storage devices support group encoding for multiple data frames to improve the subsequent decoding capability for individual data frames within the group (such as block codes). However, even when the group is used to protect data, in certain situations, once there are too many data frames (for example, 2 or more than 3) that may not be successfully decoded in the group simultaneously, the errors in the data frames may be unable to be corrected, thereby resulting in data loss in the storage device.

Therefore, how to effectively improve the data protection capability of the storage device is an urgent problem that needs to be solved at present.

### SUMMARY

The disclosure provides a data protection method and a storage device, which may improve a data protection capability of the storage device.

The disclosure provides a data protection method for use in a storage device. The data storage device includes a memory module. The memory module includes multiple physical units. The data protection method includes following steps. A first data frame is read from a first physical unit of the physical units. First type decoding operation is executed on the first data frame. If the first type decoding operation fails, whether group data complies with a preset condition is determined, where the group data includes the first data frame and a second data frame read from a second physical unit of the physical units. If the group data complies with the preset condition, second type decoding operation is executed on the group data to correct an error in the first data frame. If the group data does not comply with the preset condition, the first data frame is divided into multiple first sub-data segments, the second data frame is divided into multiple second sub-data segments, and third type decoding operation is executed based on the first sub-data segments and the second sub-data segments to correct the error in the first data frame.

The disclosure provides a storage device including a connection interface, a memory module, and a memory controller. The connection interface may be configured to connect to a host system. The memory controller may be connected to the connection interface and the memory module. The memory module may include multiple physical units, and the memory controller may be configured to: read a first data frame from a first physical unit of the physical units; execute first type decoding operation on the first data frame; if the first type decoding operation fails, determine whether group data complies with a preset condition, where the group data includes the first data frame and a second data frame read from a second physical unit of the physical units; if the group data complies with the preset condition, execute second type decoding operation on the group data to correct an error in the first data frame; if the group data does not comply with the preset condition, divide the first data frame into multiple first sub-data segments and divide the second data frame into multiple second sub-data segments, and execute third type decoding operation based on the first sub-data segments and the second sub-data segments to correct the error in the first data frame.

Based on the above, after executing the first type decoding operation on the first data frame read from the first physical unit, if the first type decoding operation fails, it may be further determined whether the group data complies with the preset condition. The group data includes the first data frame and the second data frame read from the second physical unit. If the group data complies with the preset condition, the second type decoding operation may be executed on the group data to correct the error in the first data frame. Furthermore, if the group data does not comply with the preset condition, the first data frame may be divided into the first sub-data segments and the second data frame may be divided into the second sub-data segments, and the third type decoding operation may be executed based on the first sub-data segments and the second sub-data segments to correct the error in the first data frame. Thereby, the technical problem of data loss in the storage device due to too many data frames that may not be successfully decoded in traditional methods may be improved, thereby enhancing the data protection capability of the storage device.

### BRIEF DESCRIPTION OF THE DRAWINGS

FIG. 1 is a schematic diagram of a data storage system according to an embodiment of the disclosure.

FIG. 2 is a schematic diagram of a memory controller according to an embodiment of the disclosure.

FIG. 3 is a schematic diagram of management of a memory module according to an embodiment of the disclosure.

FIG. 4 is a schematic diagram of multi-frame encoding according to an embodiment of the disclosure.

FIG. 5 is a schematic diagram of detection of a first distribution location of first error data and a second distribution location of second error data according to an embodiment of the disclosure.

FIG. 6 is a schematic diagram of execution of third type decoding operation based on a first decoding mode according to an embodiment of the disclosure.

FIG. 7 is a schematic diagram of execution of third type decoding operation based on a second decoding mode according to an embodiment of the disclosure.

FIG. 8 is a flowchart of a data protection method according to an embodiment of the disclosure.

FIG. 9 is a flowchart of a data protection method according to an embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numerals are used in the drawings and description to represent the same or similar parts.

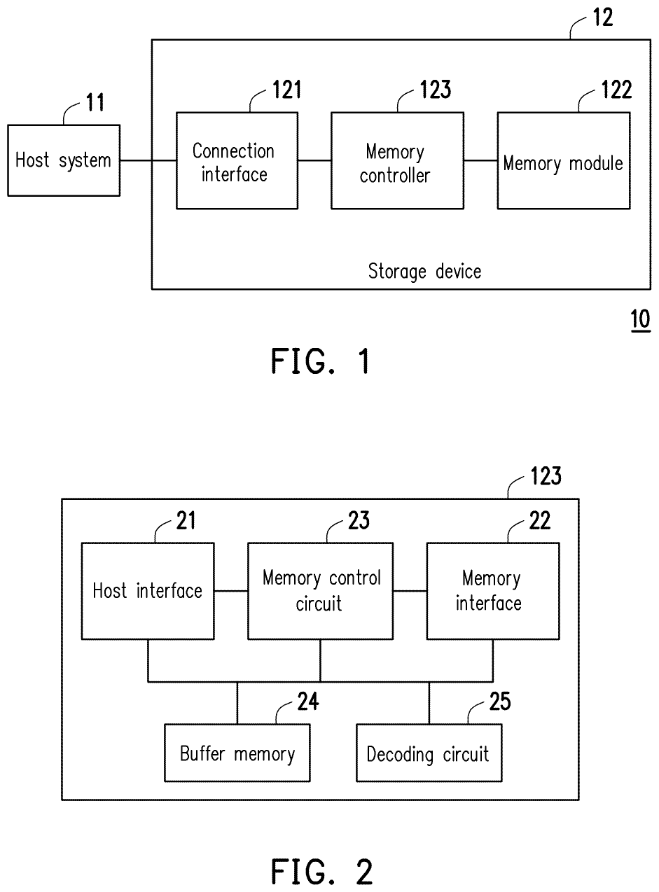

FIG. 1 is a schematic diagram of a data storage system according to an embodiment of the disclosure. Referring to FIG. 1, a data storage system 10 includes a host system 11 and a storage device 12. The storage device 12 may be connected to the host system 11 and may be configured to store data from the host system 11. For example, the host system 11 may be a smartphone, a tablet computer, a laptop computer, a desktop computer, an industrial computer, a game console, a server, or a computer system disposed in a specific carrier (such as a vehicle, an aircraft, or a ship), and a type of the host system 11 is not limited thereto. In addition, the storage device 12 may include a solid-state drive, a USB flash drive, a memory card, or other types of non-volatile storage devices.

The storage device 12 includes a connection interface 121, a memory module 122, and a memory controller 123. The connection interface 121 is configured to connect the storage device 12 to the host system 11. For example, the connection interface 121 may support an embedded multi-media card (eMMC), a universal flash storage (UFS), a peripheral component interconnect express (PCI Express), a non-volatile memory express (NVM Express), a serial advanced technology attachment (SATA), a universal serial bus (USB), or other types of connection interface standards. Therefore, the storage device 12 may communicate with (for example, exchanging signals, instructions, and/or data) the host system 11 through the connection interface 121.

The memory module 122 is configured to store data. For example, the memory module 122 may include one or multiple rewritable non-volatile memory modules. Each rewritable non-volatile memory module may include one or multiple storage unit arrays. The storage unit in the storage unit array store data in a form of voltage (also called threshold voltage). For example, the memory module 122 may include a single level cell (SLC NAND flash memory module, a multi level cell (MLC) NAND flash memory module, a triple level cell (TLC) NAND flash memory module, a quad level cell (QLC) NAND flash memory module, and/or other memory modules with the same or similar characteristics.

The memory controller 123 is connected to the connection interface 121 and the memory module 122. The memory controller 123 may be considered as a control core of the storage device 12 and may be configured to control the storage device 12. For example, the memory controller 123 may be configured to control or manage the overall or partial operation of the storage device 12. For example, the memory controller 123 may include a central processing unit (CPU), a programmable microprocessor for a common purpose or a specific purpose, a digital signal processor (DSP), a programmable controller, an application specific integrated circuit (ASIC), a programmable logic device (PLD), other similar devices, or a combination thereof. In an embodiment, the memory controller 123 may include a flash memory controller.

The memory controller 123 may send an instruction sequence to the memory module 122 to access the memory module 122. For example, the memory controller 123 may send a write instruction sequence to the memory module 122 to instruct the memory module 122 to store data in a specific storage unit. For example, the memory controller 123 may send a read instruction sequence to the memory module 122 to instruct the memory module 122 to read data from a specific storage unit. For example, the memory controller 123 may send an erase instruction sequence to the memory module 122 to instruct the memory module 122 to erase data stored in a specific storage unit. In addition, the memory controller 123 may further send other types of instruction sequences to the memory module 122 to instruct the memory module 122 to execute other types of operations, which is not limited by the disclosure. The memory module 122 may receive the instruction sequence from the memory controller 123 and access the storage units within the memory module 122 according to this instruction sequence.

FIG. 2 is a schematic diagram of a memory controller according to an embodiment of the disclosure. Referring to FIG. 1 and FIG. 2, the memory controller 123 includes a host interface 21, a memory interface 22, and a memory control circuit 23. The host interface 21 is configured to connect to the host system 11 through the connection interface 121, to communicate with the host system 11. The memory interface 22 is configured to connect to the memory module 122, to access the memory module 122.

The memory control circuit 23 may be connected to the host interface 21 and the memory interface 22. The memory control circuit 23 may be configured to control or manage the overall or partial operation of the memory controller 123. For example, the memory control circuit 23 may communicate with the host system 11 through the host interface 21 and access the memory module 122 through the memory interface 22. For example, the memory control circuit 23 may include a control circuit such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and is configured to cache data. For example, the buffer memory 24 may be configured to cache instructions and data from the host system 11 and/or data from the memory module 122.

In an embodiment, the memory controller 123 may further include a decoding circuit 25. The decoding circuit 25 is connected to the memory control circuit 23 and is configured to execute encoding and decoding on data to ensure the accuracy of the data. For example, the decoding circuit 25 may support various encoding/decoding algorithms such as a Low Density Parity Check Code (LDPC code), a Bose-Chaudhuri-Hocquenghem code (BCH code), a Reed-Solomon code (RS code), and an Exclusive OR (XOR) code. In an embodiment, the memory controller 123 may further include other types of various circuit modules (for example, a power management circuit), which is not limited by the disclosure.

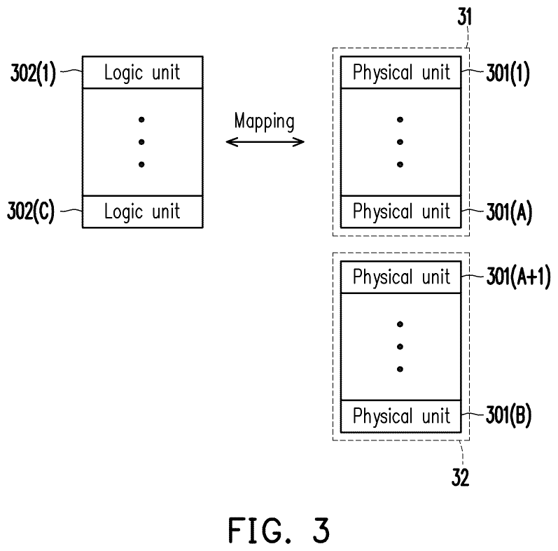

FIG. 3 is a schematic diagram of management of a memory module according to an embodiment of the disclosure. Referring to FIG. 1 to FIG. 3, the memory module 122 includes multiple physical units 301(1) to 301(B). Each physical unit includes multiple storage units and is used for non-volatile data storage.

In an embodiment, a physical unit may include one or multiple physical programmed units. A physical programmed unit may include multiple physical sectors. For example, a data capacity of a physical sector may be 512 bytes (B), and a physical programmed unit may include 32 physical sectors. However, the data capacity of the physical sector and/or the total number of physical sectors included in the physical programmed unit may be adjusted according to practical requirements, which is not limited by the disclosure. In an embodiment, the physical programmed unit may be regarded as a physical page. For example, a storage capacity of a physical programmed unit may be 16 kilobytes, and the disclosure is not limited thereto.

In an embodiment, the physical programmed unit may be the smallest unit for synchronously writing data in the memory module 122. For example, when programming operation (also called write operation) is executed on the physical programmed unit to write data to this physical programmed unit, multiple storage units in the physical programmed unit may be synchronously programmed to store corresponding data. For example, when the physical programmed unit is programmed, a write voltage may be applied to the physical programmed unit to change a threshold voltage of at least some storage units in the physical programmed unit. For example, a threshold voltage of a storage unit may reflect the bit data stored in the storage unit.

In an embodiment, a physical erase unit may include multiple physical programmed units. The physical programmed units in the physical erase unit may be erased synchronously. For example, when erase operation is executed on the physical erase unit, an erase voltage may be applied to the physical programmed units in the physical erase unit to change the threshold voltage of at least some storage units in the physical programmed units. By executing the erase operation on the physical erase unit, the data stored in the physical erase unit may be cleared.

In an embodiment, the memory control circuit 23 may logically associate the physical units 301(1) to 301(A) and 301(A+1) to 301(B) with a data area 31 and an idle area 32, respectively. The physical units 301(1) to 301(A) in the data area 31 all store data (also called user data) from the host system 11. For example, any physical unit in the data area 31 may store valid data and/or invalid data. In addition, the physical units 301(A+1) to 301(B) in the idle area 32 do not store any data (for example, valid data).

In an embodiment, if a physical unit does not store valid data, this physical unit may be associated with the idle area 32. Moreover, the physical units in the idle area 32 may be erased to clear the data in the physical units. In an embodiment, the physical unit in the idle area 32 is also called an idle physical unit. In an embodiment, the idle area 32 is also called a free pool.

In an embodiment, when data is to be stored, the memory control circuit 23 may select one or multiple physical units from the idle area 32 and instruct the memory module 122 to store the data in the selected physical units. After the data is stored in the physical units, the physical units may be associated with the data area 31. In other words, one or multiple physical units may be alternately used between the data area 31 and the idle area 32.

In an embodiment, the memory control circuit 23 may dispose multiple logic units 302(1) to 302(C) to map the physical units (that is, the physical units 301(1) to 301(A)) in the data area 31. For example, one logic unit may correspond to one logical block address (LBA) or other logical management unit. One logic unit may map to one or multiple physical units.

In an embodiment, if a physical unit is currently mapped by any logic unit, the memory control circuit 23 may determine that the data currently stored in this physical unit includes valid data. Conversely, if a physical unit is not currently mapped by any logic unit, the memory control circuit 23 may determine that this physical unit does not currently store any valid data.

In an embodiment, the memory control circuit 23 may record the mapping relationship between the logic units and the physical units in at least one management table (also called a logic-to-physical mapping table). In an embodiment, the memory control circuit 23 may instruct the memory module 122 to execute operations such as data reading, writing, or erasing according to the information in this management table (that is, the logic-to-physical mapping table).

In an embodiment, the memory control circuit 23 may manage the physical units 301(1) to 301(B) by groups (also called physical unit groups). A physical unit group may include multiple physical units. The physical unit group may be used to store multiple frames (also called data frames). For example, the physical unit may be used to store one or multiple data frames. A single physical unit group may include the physical units in the same (or different) plane, same (or different) die, and/or same (or different) Chip Enabled (CE) area in the memory module 122.

In an embodiment, the decoding circuit 25 may execute single-frame encoding on a single data frame stored in a physical unit, to protect the data in the single data frame through the odd even data generated by the single-frame encoding. In an embodiment, the decoding circuit may execute first type decoding operation on the single data frame read from a physical unit, to correct errors in the single data frame through the odd even data generated by the single-frame encoding. For example, the first type decoding operation belongs to single-frame decoding. For example, the decoding circuit 25 may execute single-frame encoding and decoding based on the LDPC algorithm, and the disclosure is not limited thereto.

In an embodiment, the decoding circuit 25 may execute multi-frames encoding on the data frames stored in the physical unit group, to protect the data in these data frames through the odd even data generated by the multi-frames encoding. In an embodiment, the decoding circuit 25 may execute second type decoding operation on the data frames read from the physical unit group, to correct errors in these data frames through the odd even data generated by the multi-frames encoding. For example, the second type decoding operation belongs to multi-frame decoding. For example, the decoding circuit 25 may execute multi-frame encoding and decoding based on the BCH code, the RS code, and/or the XOR code, and the disclosure is not limited thereto.

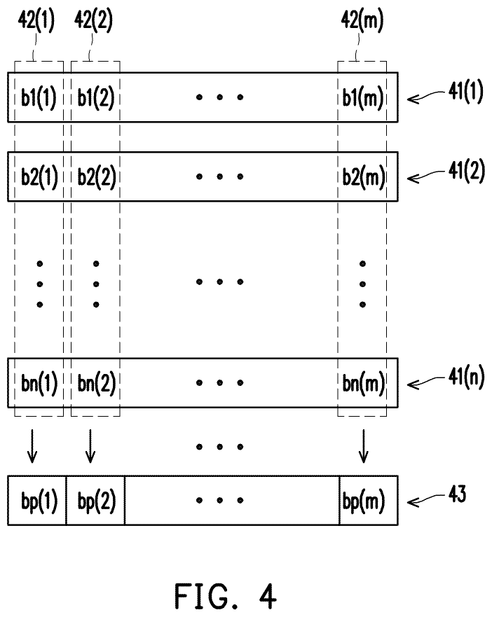

FIG. 4 is a schematic diagram of multi-frame encoding according to an embodiment of the disclosure. Referring to FIG. 4, data frames 41(1) to 41(n) include data to be stored in a physical unit group (also called a first physical unit group). For example, the first physical unit group may include physical units 301(1) to 301(n) in FIG. 3. A data frame 41(i) includes data to be stored in a physical unit 301(i), where i is between 1 and n. The data in the data frames 41(1) to 41(n) may include data indicated for storage by a write instruction sent from the host system 11. Alternatively, the data in the data frames 41(1) to 41(n) may also include data read from the memory module 122 and waiting to be written back to the memory module 122.

In an embodiment, the decoding circuit 25 may execute multi-frame encoding on the data frames 41(1) to 41(n) to generate a data frame 43. The data in the data frame 43 includes odd even data for protecting the data frames 41(1) to 41(n). For example, when multi-frame decoding is executed on the data frames 41(1) to 41(n), the odd even data in data frame 43 may be used to detect and/or correct errors in the data frames 41(1) to 41(n).

In an embodiment, in multi-frame encoding, the data in the data frames 41(1) to 41(n) may be encoded based on the location of each bit in the data frame. For example, bits b1(1) to bn(1) located at a location 42(1) in the data frames 41(1) to 41(n) may be encoded to obtain a bit bp(1) in the data frame 43, bits b1(2) to bn(2) located at a location 42(2) in the data frames 41(1) to 41(n) may be encoded to obtain a bit bp(2) in the data frame 43, and so on, and bits b1(m) to bn(m) located at a location 42(m) in the data frames 41(1) to 41(n) may be encoded to obtain a bit bp(m) in data frame 43. Later, in multi-frame decoding, the bits (also called odd even data) bp(1) to bp(m) in the data frame 43 may be used to detect and/or correct error bits in the data frames 41(1) to 41(n). For example, a bit bp(i) in the data frame 43 may be used to detect or correct one or multiple error bits at a location 42(i).

It should be noted that, in an embodiment, the arrangement of multiple bits covered by any one of the locations 42(1) to 42(m) may be different from the arrangement shown in FIG. 4, which is not limited by the disclosure. Furthermore, in an embodiment, a number of data frames 43 including the odd even data may also be 2 or more, to provide different or better multi-frame decoding capabilities, which is not limited by the disclosure.

In an embodiment, the decoding circuit 25 may execute single-frame encoding on the data frames 41(1) to 41(n) and 43 respectively to generate odd even data for protecting each data frame. Subsequently, in single frame decoding, this odd even data may be used to detect and/or correct error bits in each data frame.

In an embodiment, the odd even data generated by executing multi-frame encoding in the data frame 43 may also be called a redundant array of independent disks (RAID) error correction code. In an embodiment, the data frames 41(1) to 41(n) and 43 may be combined and viewed as group data (also called a block code). The data frames 41(1) to 41(n) and 43 may be stored in the first physical unit group.

In an embodiment, when it is desired to read data stored in a physical unit (also called a first physical unit) of the first physical unit group, the memory control circuit 23 may send a read instruction sequence to the memory module 122. The read instruction sequence may instruct the memory module 122 to read data from the first physical unit. The memory module 122 may transmit the data read from the first physical unit (also called the first data frame) back to the memory control circuit 23 according to the read instruction sequence. The decoding circuit 25 may execute the first type decoding operation on the first data frame. For example, if the data in the first data frame is encoded based on the LDPC algorithm for single-frame encoding, the decoding circuit 25 may execute the first type decoding operation on the first data frame based on the LDPC algorithm.

In an embodiment, if the first type decoding operation executed on the first data frame is successful (indicating that the data in the first data frame is correct and/or all data in the first data frame has been corrected), the decoding circuit 25 may output the successfully decoded data. However, if the first type decoding operation executed on the first data frame fails (indicating that the errors in the first data frame may not be fully corrected), the decoding circuit 25 may initiate a procedure of multi-frame decoding to execute the second type decoding operation on the group data (also called the first group data) including the first data frame. For example, if the first group data was originally encoded based on the XOR algorithm for multi-frame encoding, the decoding circuit 25 may similarly execute the second type decoding operation on the first group data based on the XOR algorithm.

In an embodiment, the data frame which may not be corrected by the first type decoding operation may be called a UECC frame. In an embodiment, in the second type decoding operation based on the XOR algorithm, only one UECC frame may exist simultaneously in the same group data. If the same group data simultaneously includes two or multiple UECC frames, the second type decoding operation based on the XOR algorithm has a high probability of failing (that is, unable to completely correct the errors in these UECC frames). It should be noted that if the second type decoding operation is executed based on other algorithms, the upper limit of a number of UECC frames in the same group data which may be successfully corrected by executing the second type decoding operation may be different, which is not limited by the disclosure.

In an embodiment, after the first type decoding operation executed on the first data frame fails, the memory control circuit 23 may determine whether the first group data complies with a preset condition. For example, the preset condition may include that the total number of data frames (that is, the UECC frames) in the first group data that may not be successfully decoded through the first type decoding operation is not greater than a preset number. For example, assuming the decoding circuit 25 is preset to execute multi-frame decoding based on the XOR algorithm, the preset number may be “1”, but the disclosure is not limited thereto.

In an embodiment, if the total number of data frames (that is, the UECC frames) in the first group data that are unable to be successfully decoded through the first type decoding operation does not exceed the preset number, the memory control circuit 23 may determine that the first group data complies with the preset condition. Alternatively, in an embodiment, if the total number of data frames (that is, the UECC frames) in the first group data that are unable to be successfully decoded through the first type decoding operation exceeds the preset number, the memory control circuit 23 may determine that the first group data does not comply with the preset condition.

In an embodiment, if the first group data complies with the preset condition, it indicates that the subsequent second type decoding operation to be executed on the first group data should be successful (that is, successfully correcting all errors in the first data frame). Therefore, when the first group data complies with the preset condition, the memory control circuit 23 may execute the second type decoding operation on the first group data to correct errors in the first data frame. However, if the first group data does not comply with the preset condition, it indicates that the subsequent second type decoding operation to be executed on the first group data has a high probability of failure. Therefore, when the first group data does not comply with the preset condition, the memory control circuit 23 may not execute the second type decoding operation on the first group data. Thereby, unnecessary waste of system resources may be avoided.

Traditionally, when the total number of UECC frames in a single group data exceeds the decoding capability of multi-frame decoding, the decoding for this group data is often determined to fail, which results in data loss in the storage device 12. However, in an embodiment, if the first group data does not comply with the preset condition, the memory control circuit 23 may not directly execute the determination that the decoding of the first data frame has failed or may directly discard the first data frame.

In an embodiment, if it is determined that the first group data does not comply with the preset condition, the memory control circuit 23 may further divide the first data frame into multiple first sub-data segments and divide another data frame (also called the second data frame) in the first group data into multiple second sub-data segments. For example, the second data frame is data read from another physical unit (also called the second physical unit) in the first physical unit group. Both the first data frame and the second data frame belong to the UECC frames. Afterwards, the memory control circuit 23 may execute another type decoding operation (also called the third type decoding operation) based on the first sub-data segments and the second sub-data segments to correct errors in the first data frame. It should be noted that the third type decoding operation may be different from the first type decoding operation and the second type decoding operation. Thereby, the third type decoding operation may improve the technical problem of data loss in the storage device 12 due to too many data frames that may not be successfully decoded in traditional methods.

In an embodiment, after determining that the first group data does not comply with the preset condition, the memory control circuit 23 may detect the distribution location (also called the first distribution location) of the error data (also called the first error data) in the first sub-data segments, and detect the distribution location (also called the second distribution location) of the error data (also called the second error data) in the second sub-data segments. For example, the first distribution location may reflect that the first error data is located in at least one sub-data segment of the first sub-data segments, and/or the second distribution location may reflect that the second error data is located in at least one sub-data segment of the second sub-data segments. Afterwards, the memory control circuit 23 may determine a decoding mode for the third type decoding operation according to the first distribution location and the second distribution location. For example, according to the first distribution location and the second distribution location, the memory control circuit 23 may determine that the decoding mode for the third type decoding operation is one of multiple candidate decoding modes.

In an embodiment, the memory control circuit 23 may detect whether the first type decoding operation is successful in decoding each of the first sub-data segments according to a decoding result of the first type decoding operation previously executed on the first data frame. If the first type decoding operation fails to decode at least some data segments (also called first target data segments) of the first sub-data segments, the memory control circuit 23 may determine that at least a portion of the error data in the first error data is located in the first target data segments. However, if the first type decoding operation successfully decodes (that is, does not fail to decode) at least some data segments (also called second target data segments) of the first sub-data segments, the memory control circuit 23 may determine that the first error data is not located in the second target data segments. In other words, in an embodiment, according to the decoding result of the first type decoding operation previously executed on the first data frame, the memory control circuit 23 may obtain a first distribution location of the first error data in the first sub-data segments.

In an embodiment, the decoding circuit 25 may execute the first type decoding operation on the second data frame. According to a decoding result of the second type decoding operation executed on the second data frame, the memory control circuit 23 may detect whether the first type decoding operation is successful in decoding each of the second sub-data segments. If the first type decoding operation fails to decode at least some data segments (also called third target data segments) in the second sub-data segments, the memory control circuit 23 may determine that at least a portion of the error data in the second error data is located in the third target data segments. However, if the first type decoding operation successfully decodes (that is, does not fail to decode) at least some data segments (also called fourth target data segments) in the second sub-data segments, the memory control circuit 23 may determine that the second error data is not located in the fourth target data segments. In other words, in an embodiment, according to the decoding result of the first type decoding operation previously executed on the second data frame, the memory control circuit 23 may obtain a second distribution location of the second error data in the second sub-data segments.

In an embodiment, it is assumed that a data amount of a data frame is 16 KB, and a data amount of a sub-data segment is 2 KB, then the data frame may be divided into 8 sub-data segments. However, in an embodiment, the data amount of the data frame, the data amount of the sub-data segment, and the total number of sub-data segments included in the data frame may all be adjusted according to practical requirements, which is not limited by the disclosure.

In an embodiment, the memory control circuit 23 may determine the data amount of the sub-data segment according to the basic unit of the first type decoding operation executed by the decoding circuit 25. For example, assuming that in the first type decoding operation for a first data frame with a data amount of 16 KB, the odd even data used for decoding the first data frame decodes the first data frame in basic decoding units of 2 KB, the memory control circuit 23 may set the data amount of the sub-data segment (that is, the first sub-data segment) in the first data frame to 2 KB. Alternatively, assuming that in the first type decoding operation for the first data frame with the data amount of 16 KB, the odd even data used for decoding the first data frame decodes the first data frame in basic decoding units of 4 KB, the memory control circuit 23 may set the data amount of the sub-data segment (that is, the first sub-data segment) in the first data frame to 4 KB, and so on.

In an embodiment, if the aforementioned detection result shows that the first error data is located in the i-th sub-data segment of the first sub-data segments, the second error data is located in the j-th sub-data segment among the multiple second sub-data segments, and i is not equal to j, the memory control circuit 23 may determine a decoding mode for the third type decoding operation to be a certain decoding mode (also called a first decoding mode). For example, the first decoding mode may be one of the candidate decoding modes. Then, the memory control circuit 23 (and/or the decoding circuit 25) may execute the third type decoding operation based on the first decoding mode.

In an embodiment, if the aforementioned detection result shows that the first error data is located in the i-th sub-data segment of the first sub-data segments, and the second error data is located in the i-th sub-data segment among the multiple second sub-data segments, the memory control circuit 23 may determine another decoding mode (also called a second decoding mode) as the decoding mode for the third type decoding operation. For example, the second decoding mode may be another one among the candidate decoding modes. The first decoding mode is different from the second decoding mode. Then, the memory control circuit 23 (and/or the decoding circuit 25) may execute the third type decoding operation based on the second decoding mode.

In an embodiment, it may be assumed that the first error data is located in the i-th sub-data segment of the first sub-data segments, the second error data is located in the j-th sub-data segment of the second sub-data segments, and i is not equal to j. In the first decoding mode, the memory control circuit 23 may obtain decoding data (also called transient decoding data) according to a data frame (also called the third data frame) read from at least one physical unit (also called the third physical unit) in the first physical unit group. For example, the third physical unit may include all physical units in the first physical unit group except the first physical unit and the second physical unit. For example, the memory control circuit 23 may execute preset calculations (for example, an XOR operation) on the third data frame based on a algorithm (for example, an XOR algorithm) adopted by the second type decoding operation to obtain the transient decoding data. The memory control circuit 23 may obtain reference data (also called the first reference data) according to the transient decoding data and the second data frame. Afterwards, the memory control circuit 23 may update the data in the i-th sub-data segment of the first sub-data segments according to the data in the i-th sub-data segment of the first reference data. Thereby, the error data (that is, the first error data) in the i-th sub-data segment of the first sub-data segments may be corrected.

In an embodiment, it may be assumed that the first error data is located in the i-th sub-data segment of the first sub-data segments, and the second error data is located in the i-th sub-data segment of the second sub-data segments. In the second decoding mode, the memory control circuit 23 may also obtain transient decoding data according to the third data frame. The memory control circuit 23 may identify the data type of specific bits (also called reference bits) in the transient decoding data. For example, the reference bit may be the k-th bit in the i-th sub-data segment of the transient decoding data. Then, according to the data type of the reference bit, the memory control circuit 23 may update at least one of the specific bits (also called first bits) in the first sub-data segments and the specific bits (also called second bits) in the second sub-data segments. It should be noted that the first bit is the k-th bit in the i-th sub-data segment of the first sub-data segments, and the second bit is the k-th bit in the i-th sub-data segment of the second sub-data segments. Thereby, the error data (that is, the first error data) in the i-th sub-data segment of the first sub-data segments and/or the error data (that is, the second error data) in the i-th sub-data segment of the second sub-data segments may be corrected.

In an embodiment, after identifying the data type of the reference bit, if the data type is a certain type (also called the first type), the updated first bit and the updated second bit may comply with a certain calculation logic (also called the first calculation logic). However, if the data type is another type (also called the second type), the updated first bit and the updated second bit may comply with another calculation logic (also called the second calculation logic). The first type is different from the second type. The first calculation logic is different from the second calculation logic.

Taking the XOR algorithm used in multi-frame encoding and decoding as an example, if the reference bit is “0”, then the updated first bit and the updated second bit need to be “1”, “1” or “0”, “0” respectively. However, if the reference bit is “1”, then the updated first bit and the updated second bit need to be “1”, “0” or “0”, “1” respectively.

Therefore, even without executing the second type decoding operation, through the third type decoding operation, errors in the first data frame (and/or the second data frame) may be corrected, thereby improving the technical problem of data loss in the storage device 12 due to too many data frames which may not be successfully decoded in conventional systems, and enhancing the data protection capability of the storage device 12.

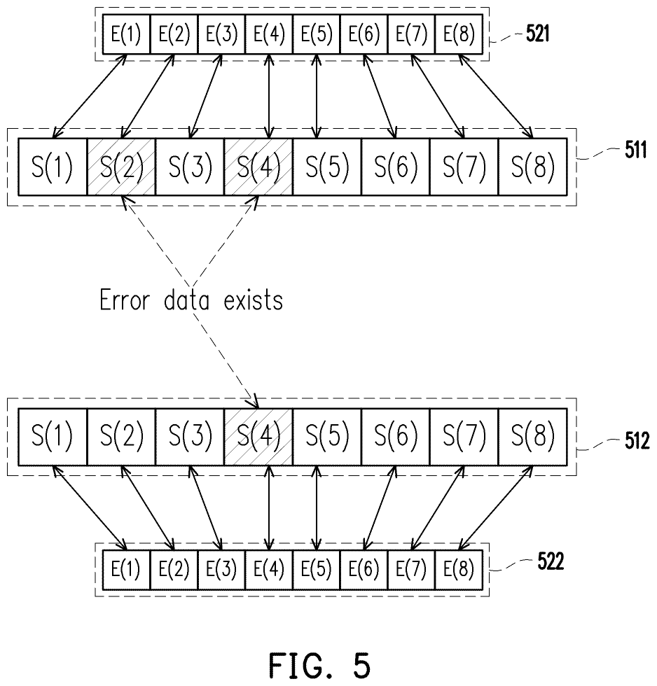

FIG. 5 is a schematic diagram of detection of a first distribution location of first error data and a second distribution location of second error data according to an embodiment of the disclosure. Refer to FIG. 5, it is assumed that a data frame 511 is the first data frame, and data frame 512 is the second data frame. The data frame 511 includes multiple sub-data segments S(1) to S(8), and data frame 512 also includes multiple sub-data segments S(1) to S(8). Furthermore, it is assumed that odd even data 521 includes multiple sub-data segments E(1) to E(8), and odd even data 522 includes multiple sub-data segments E(1) to E(8).

According to the disclosure, after executing the first type decoding operation on the data frame 511 based on the odd even data 521, it is assumed that the decoding of sub-data segments S(1), S(3), and S(5) to S(8) in the data frame 511 based on sub-data segments E(1), E(3), and E(5) to E(8) in the odd even data 521 is successful, and the decoding of sub-data segments S(2) and S(4) in the data frame 511 based on sub-data segments E(2) and E(4) in the odd even data 521 fails. In this situation, the memory control circuit 23 may determine that error data (that is, the first error data) exists in sub-data segments S(2) and S(4) of the data frame 511.

In another aspect, after executing the first type decoding operation on the data frame 512 according to the odd even data 522, it is assumed that the decoding of the sub-data segments S(1) to S(3) and S(5) to S(8) in the data frame 512 based on the sub-data segments E(1) to E(3) and E(5) to E(8) in the odd even data 522 is successful, and the decoding of the sub-data segment S(4) in the data frame 512 based on the sub-data segment E(4) in the odd even data 522 fails. In this situation, the memory control circuit 23 may determine that error data (that is, the second error data) exists in the sub-data segment S(4) of the data frame 512.

In an embodiment, the data frames 511 and 512 are both UECC frames, and the total number of UECCs in the first data group exceeds the upper limit (that is, the first data group does not comply with the preset condition). Therefore, in the embodiment of FIG. 5, even if the second type decoding operation is executed on the data frame 511 and/or the data frame 512, this second type decoding operation may have a high probability of failure.

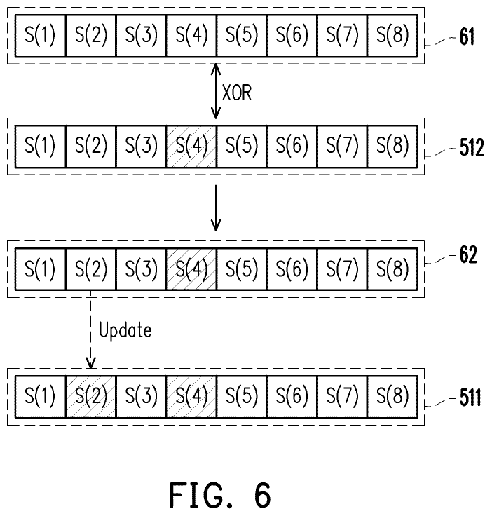

FIG. 6 is a schematic diagram of execution of third type decoding operation based on a first decoding mode according to an embodiment of the disclosure. Referring to FIG. 6, continuing from the embodiment in FIG. 5, it is assumed that the sub-data segments S(2) in other data frames (that is, the third data frame) of the first group data do not contain any errors. In this situation, the memory control circuit 23 may execute the third type decoding operation based on the first decoding mode to correct the errors in the sub-data segment S(2) of the data frame 511.

In an embodiment, the memory control circuit 23 may obtain the transient decoding data 61 according to other data frames (that is, the third data frame) in the first group data. For example, the memory control circuit 23 may execute a preset calculation (for example, the XOR operation) on the third data frame in the first group data to obtain the transient decoding data 61. For example, the transient decoding data 61 may reflect a calculation result of executing the preset calculation (for example, the XOR operation) on the third data frame.

After obtaining the transient decoding data 61, the memory control circuit 23 may obtain reference data 62 (that is, the first reference data) according to the transient decoding data 61 and the data frame 512. For example, the memory control circuit 23 may execute a preset calculation (for example, the XOR operation) on the transient decoding data 61 and the data frame 512 to obtain the reference data 62. For example, the reference data 62 may reflect the calculation result of executing the preset calculation (for example, the XOR operation) on the transient decoding data 61 and the data frame 512. Afterwards, the memory control circuit 23 may update the data in the sub-data segment S(2) of the data frame 511 according to the data in the sub-data segment S(2) of the reference data 62. For example, the memory control circuit 23 may replace the data in the sub-data segment S(2) of the data frame 511 by the data in the sub-data segment S(2) of the reference data 62.

It should be noted that, in the entire first group data in the embodiment of FIG. 6, only the sub-data segment S(2) in the data frame 511 contains an error, while the sub-data segments S(2) in the remaining data frames (including the second data frame and the third data frame) do not contain any errors. Therefore, by executing a preset calculation (that is, the XOR operation) on the data frame 512 (that is, the second data frame) and the transient decoding data 61 (or the third data frame), the data in the sub-data segment S(2) of the finally obtained reference data 62 may be considered as the correct data corresponding to the sub-data segment S(2) in the data frame 511. Consequently, updating the data in the sub-data segment S(2) of the data frame 511 according to the data in the sub-data segment S(2) of the reference data 62 may achieve the technical effect of correcting the error in the sub-data segment S(2) of the data frame 511.

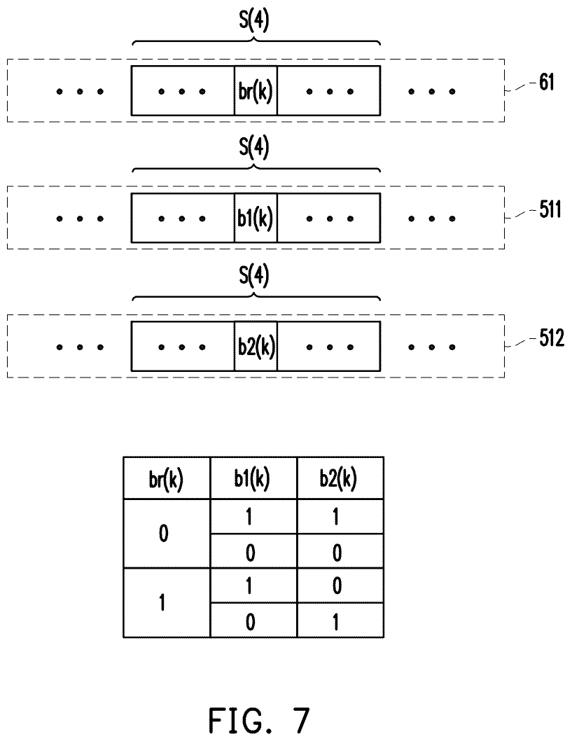

FIG. 7 is a schematic diagram of execution of third type decoding operation based on a second decoding mode according to an embodiment of the disclosure. Referring to FIG. 7, continuing from the embodiment of FIG. 5 (or FIG. 6), it is assumed that there are no errors in the sub-data segments S(4) of other data frames (that is, the third data frame) in the first group data. In this situation, the memory control circuit 23 may execute the third type decoding operation based on the second decoding mode to correct errors in the sub-data segment S(4) of data frame 511 (and the sub-data segment S(4) of data frame 512).

In an embodiment, after obtaining the transient decoding data 61 of FIG. 6, the memory control circuit 23 may determine the bit br(k) (that is, the kth bit in the sub-data segment S(4) of the transient decoding data 61) in the sub-data segment S(4) of the transient decoding data 61 as a reference bit. The memory control circuit 23 may identify the data type of the bit br(k). According to the data type of the bit br(k), the memory control circuit 23 may decide whether to update (for example, flip) the bit b1(k) (that is, the kth bit in the sub-data segment S(4) of the data frame 511) in the sub-data segment S(4) of the data frame 511 and/or the bit b2(k) (that is, the kth bit in the sub-data segment S(4) of the data frame 512) in the sub-data segment S(4) of the data frame 512.

In an embodiment, when the bit br(k) is “0”, the bits b1(k) and b2(k) need to be “1” and “1” respectively, or “0” and “0” respectively, to comply with the calculation logic corresponding to the bit br(k) being “0”. Alternatively, in an embodiment, when the bit br(k) is “1”, the bits b1(k) and the b2(k) need to be “1” and “0” respectively, or “0” and “1” respectively, to comply with the calculation logic corresponding to the bit br(k) being “1”.

In an embodiment, if the bit b1(k) and/or the b2(k) do not comply with the calculation logic corresponding to the data type of the bit br(k), the memory control circuit 23 may update the bit b1(k) and/or the b2(k). For example, it is assumed that the bit br(k) is “0”, and the bits b1(k) and the b2(k) are “0” and “1” respectively, the memory control circuit 23 may update the bit b1(k) from “0” to “1” to satisfy the calculation logic corresponding to the bit br(k) being “0”. Alternatively, it is assumed that the bit br(k) is “1”, and the bits b1(k) and the b2(k) are both “1”, the memory control circuit 23 may update the bit b2(k) from “1” to “0” to satisfy the calculation logic corresponding to the bit br(k) being “1”.

It should be noted that in the entire first group data in the embodiment of FIG. 7, only the sub-data segments S(4) in data frames 511 and 512 contain errors, while the sub-data segments S(4) in the remaining data frames do not contain errors. Therefore, by identifying the data type of the bit br(k) in the sub-data segment S(4) of the transient decoding data 61, the memory control circuit 23 may quickly determine whether at least one of the bits b1(k) and b2(k) is an error bit. By correcting the error bits in the sub-data segments S(4) of the data frame 511 and/or the data frame 512 one by one, the technical effect of correcting errors in the sub-data segments S(4) of the data frame 511 and/or the data frame 512 may also be achieved.

In an embodiment, after updating the first bit (for example, the bit b1(k) in FIG. 7), the memory control circuit 23 may re-detect the total number of error bits in the first data frame. For example, after updating the first bit, the decoding circuit 25 may re-execute the first type decoding operation on the first data frame. The memory control circuit 23 may determine the total number of error bits in the first data frame according to the result of this executed first type decoding operation.

In an embodiment, after updating the first bit, if the total number of error bits in the first data frame indeed decreases, it indicates that the current update to the first bit is correct. In this situation, the memory control circuit 23 may maintain the update result of the first bit. However, in an embodiment, after updating the first bit, if the total number of error bits in the first data frame does not decrease (or even increases), it indicates that the current update to the first bit is not correct. In this situation, the memory control circuit 23 may restore the first bit (for example, restore the first bit from the updated “0” to “1” or from “1” to “0”).

In other words, in an embodiment, after updating the first bit, the memory control circuit 23 may determine whether the current update of the first bit is correct based on the change in the number of error bits in the first data frame. If the current update is not correct, the memory control circuit 23 may restore the first bit to avoid forming new error bits in the first data frame. Similarly, after updating the second bit (for example, the bit b2(k) in FIG. 7), the memory control circuit 23 may determine whether the current update of the second bit is correct based on the change in the number of error bits in the second data frame, and may execute subsequent operations accordingly.

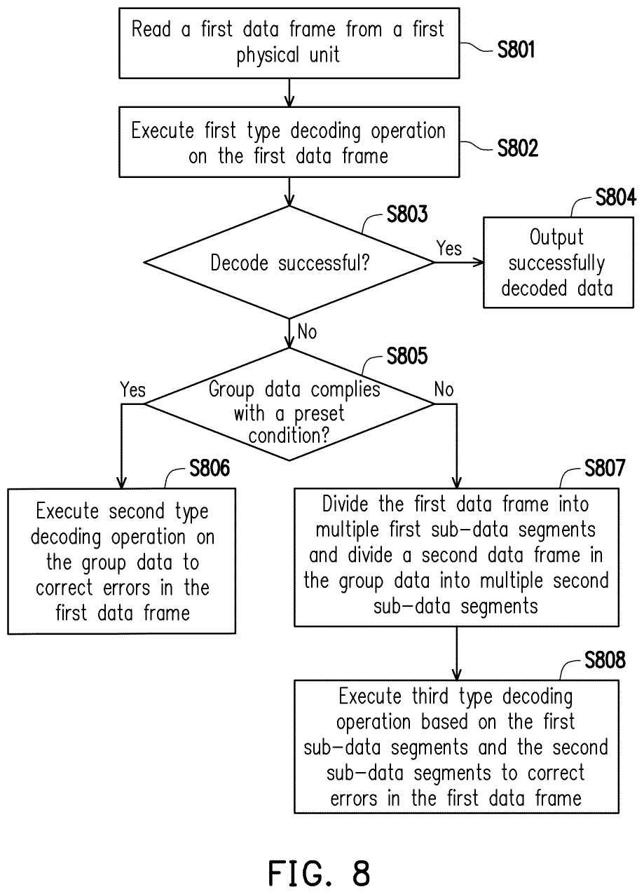

FIG. 8 is a flowchart of a data protection method according to an embodiment of the disclosure Referring to FIG. 8, in step S801, the first data frame is read from the first physical unit. In step S802, the first type decoding operation is executed on the first data frame. In step S803, it is determined whether the first type decoding operation executed on the first data frame is successful (or failed). If the first type decoding operation executed on the first data frame is successful, in step S804, the successfully decoded data is output.

If the first type decoding operation executed on the first data frame is not successful (that is, failed), in step S805, it is determined whether the group data complies with a preset condition. The group data includes the first data frame and the second data frame read from the second physical unit. If the group data complies with the preset condition (for example, the total number of UECC frames in the group data is not greater than a preset number), in step S806, the second type decoding operation may be executed on the group data to correct errors in the first data frame. Afterwards, if the group data does not comply with the preset condition (for example, the total number of UECC frames in the group data is greater than the preset number), in step S807, the first data frame may be divided into the first sub-data segments and the second data frame may be divided into the second sub-data segments. In step S808, the third type decoding operation may be executed based on the first sub-data segments and the second sub-data segments to correct errors in the first data frame.

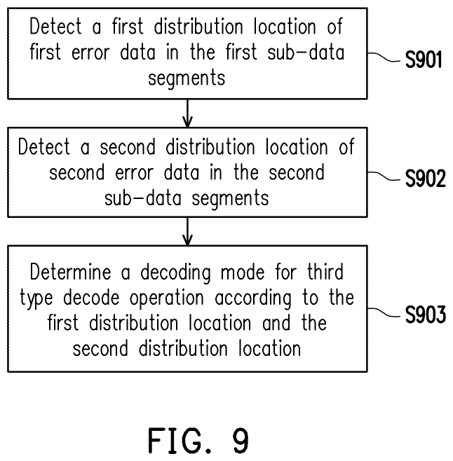

FIG. 9 is a flowchart of a data protection method according to an embodiment of the disclosure. Referring to FIG. 9, in step S901, the first distribution location of the first error data in the first sub-data segments is detected. In step S902, the second distribution location of the second error data in the second sub-data segments is detected. In step S903, the decoding mode for the third type decoding operation is determined according to the first distribution location and the second distribution location.

However, the steps in FIG. 8 and FIG. 9 have been explained in detail as above, and are not repeated here. It is worth noting that the steps in FIG. 8 and FIG. 9 may be implemented as multiple program codes or circuits, which is not limited by the disclosure. In addition, the methods of FIG. 8 and FIG. 9 may be used in conjunction with the above exemplary embodiments, or may be used independently, which is not limited by the disclosure.

In summary, the data protection method and the storage device provided by the disclosure may, when necessary, improve the error correction capability for the data frames by finely dividing the data frames and utilizing the encoding characteristics of the group data. In particular, for data frames that may have been abandoned in traditional decoding processes, the data protection method and the storage device provided by the disclosure still have the opportunity to correct the error therein, thereby enhancing the data protection capability of the storage device.

Finally, it should be noted that: the aforementioned embodiments are only used to illustrate the technical solutions of the disclosure, and are not intended to limit thereto. Although the disclosure has been described in detail with reference to the foregoing embodiments, those skilled in the art should understand that: the technical solutions described in the foregoing embodiments may still be modified, or equivalent substitutions for some or all of the technical features may be made; and these modifications or substitutions do not cause the corresponding technical solutions to deviate from the scope of the technical solutions of the embodiments of the disclosure.

What is claimed is:

1. A data protection method, for use in a storage device, wherein the storage device comprises a memory module, the memory module comprises a plurality of physical units, and the data protection method comprises:
reading a first data frame from a first physical unit of the plurality of physical units;
executing first type decoding operation on the first data frame;
if the first type decoding operation fails, determining whether group data complies with a preset condition, wherein the group data comprises the first data frame and a second data frame read from a second physical unit of the plurality of physical units; and
if the group data does not comply with the preset condition, dividing the first data frame into a plurality of first sub-data segments and divide the second data frame into a plurality of second sub-data segments, and executing third type decoding operation based on the plurality of first sub-data segments and the plurality of second sub-data segments, to correct an error in the first data frame.

2. The data protection method according to claim 1, wherein the step of determining whether group data complies with a preset condition also comprises:
if the group data complies with the preset condition, executing second type decoding operation to the group data to correct the error in the first data frame; and
the preset condition comprises that a total number of data frames in the group data which are unable to be successfully decoded by the first type decoding operation is not greater than a preset number.

3. The data protection method according to claim 1, wherein the step of executing the third type decoding operation based on the plurality of first sub-data segments and the plurality of second sub-data segments comprises:
detecting a first distribution location of the first error data in the plurality of first sub-data segments;
detecting a second distribution location of the second error data in the plurality of second sub-data segments; and
according to the first distribution location and the second distribution location, determining a decoding mode for the third type decoding operation.

4. The data protection method according to claim 3, wherein the step of detecting the first distribution location of the first error data in the plurality of first sub-data segments comprises:
according to a decoding result of the first type decoding operation executed on the first data frame, detecting whether the first type decoding operation is successful in decoding each of the plurality of first sub-data segments; and
if the first type decoding operation fails to decode a target data segment in the plurality of first sub-data segments, determining that at least a portion of data in the first error data is located in the target data segment.

5. The data protection method according to claim 3, wherein the step of determining the decoding mode for the third type decoding operation according to the first distribution location and the second distribution location comprises:
if the first error data is located in an ith sub-data segment of the plurality of first sub-data segments, the second error data is located in the jth sub-data segment of the plurality of second sub-data segments, and i is not equal to j, determining the decoding mode for the third type decoding operation to be a first decoding mode; and
if the first error data is located in the ith sub-data segment of the plurality of first sub-data segments, and the second error data is located in the ith sub-data segment of the plurality of second sub-data segments, determining the decoding mode for the third type decoding operation to be a second decoding mode, wherein the first decoding mode is different from the second decoding mode.

6. The data protection method according to claim 1, wherein the step of executing the third type decoding operation based on the plurality of first sub-data segments and the plurality of second sub-data segments comprises:
in the first decoding mode for the third type decoding operation, obtaining transient decoding data according to a third data frame read from a third physical unit of the plurality of physical units;
obtaining first reference data according to the transient decoding data and the second data frame; and
updating the data in the i-th sub-data segment of the plurality of first sub-data segments according to the data in the i-th sub-data segment of the first reference data.

7. The data protection method according to claim 1, wherein the step of executing the third type decoding operation based on the plurality of first sub-data segments and the plurality of second sub-data segments comprises:
in a second decoding mode for the third type decoding operation, obtaining transient decoding data according to a third data frame read from a third physical unit of the plurality of physical units;
identifying a data type of a reference bit in the transient decoding data, wherein the reference bit is a kth bit in an ith sub-data segment of the transient decoding data; and
according to the data type, updating at least one of a first bit in the plurality of first sub-data segments and a second bit in the plurality of second sub-data segments,
wherein the first bit is a kth bit in the ith sub-data segment of the plurality of first sub-data segments, and the second bit is a kth bit in the ith sub-data segment of the plurality of second sub-data segments.

8. The data protection method according to claim 7, wherein if the data type is a first type, the updated first bit and the updated second bit comply with a first calculation logic, and
if the data type is a second type, then the updated first bit and the updated second bit comply with a second calculation logic,
wherein the first type is different from the second type, and the first calculation logic is different from the second calculation logic.

9. The data protection method according to claim 7, wherein the step of executing the third type decoding operation based on the plurality of first sub-data segments and the plurality of second sub-data segments further comprises:
after updating the first bit, detecting a total number of error bits in the first data frame; and
if the total number of error bits in the first data frame does not decrease, restoring the first bit.

10. The data protection method according to claim 1, wherein the first type decoding operation belongs to single frame decoding, and the second type decoding operation belongs to multi-frame decoding.

11. A storage device, comprising:
a connection interface, configured to connect to a host system;
a memory module; and
a memory controller, connected to the connection interface and the memory module,
wherein the memory module comprises a plurality of physical units, and the memory controller is configured to:
read a first data frame from a first physical unit of the plurality of physical units;
execute first type decoding operation on the first data frame;
if the first type decoding operation fails, determine whether group data complies with a preset condition, wherein the group data comprises the first data frame and a second data frame read from a second physical unit of the plurality of physical units; and
if the group data does not comply with the preset condition, divide the first data frame into a plurality of first sub-data segments and divide the second data frame into a plurality of second sub-data segments, and execute third type decoding operation based on the plurality of first sub-data segments and the plurality of second sub-data segments, to correct an error in the first data frame.

12. The storage device according to claim 11, wherein the operation of the memory controller determining whether group data complies with the preset condition also comprises:
if the group data complies with the preset condition, executing second type decoding operation to the group data to correct the error in the first data frame; and
the preset condition comprises that a total number of data frames in the group data which are unable to be successfully decoded by the first type decoding operation is not greater than a preset number.

13. The storage device according to claim 11, wherein the operation of the memory controller executing the third type decoding operation based on the plurality of first sub-data segments and the plurality of second sub-data segments comprises:
detecting a first distribution location of the first error data in the plurality of first sub-data segments;
detecting a second distribution location of the second error data in the plurality of second sub-data segments; and
according to the first distribution location and the second distribution location, determining a decoding mode for the third type decoding operation.

14. The storage device according to claim 13, wherein the operation of the memory controller detecting the first distribution location of the first error data in the plurality of first sub-data segments comprises:
according to a decoding result of the first type decoding operation executed on the first data frame, detecting whether the first type decoding operation is successful in decoding each of the plurality of first sub-data segments; and
if the first type decoding operation fails to decode a target data segment in the plurality of first sub-data segments, determining that at least a portion of data in the first error data is located in the target data segment.

15. The storage device according to claim 13, wherein the operation of the memory controller determining the decoding mode for the third type decoding operation based on the first distribution location and the second distribution location comprises:
if the first error data is located in an ith sub-data segment of the plurality of first sub-data segments, the second error data is located in a jth sub-data segment of the plurality of second sub-data segments, and i is not equal to j, determining the decoding mode for the third type decoding operation to be a first decoding mode; and
if the first error data is located in the ith sub-data segment of the plurality of first sub-data segments, and the second error data is located in the ith sub-data segment of the plurality of second sub-data segments, determining the decoding mode for the third type decoding operation to be a second decoding mode, wherein the first decoding mode is different from the second decoding mode.

16. The storage device according to claim 11, wherein the operation of the memory controller executing the third type decoding operation based on the plurality of first sub-data segments and the plurality of second sub-data segments comprises:
in the first decoding mode for the third type decoding operation, obtaining transient decoding data according to a third data frame read from a third physical unit of the plurality of physical units;
obtaining first reference data according to the transient decoding data and the second data frame; and
updating the data in an i-th sub-data segment of the plurality of first sub-data segments according to the data in an i-th sub-data segment of the first reference data.

17. The storage device according to claim 11, wherein the operation of the memory controller executing the third type decoding operation based on the plurality of first sub-data segments and the plurality of second sub-data segments comprises:
in a second decoding mode for the third type decoding operation, obtaining transient decoding data according to a third data frame read from a third physical unit of the plurality of physical units;
identifying a data type of a reference bit in the transient decoding data, wherein the reference bit is a kth bit in an ith sub-data segment of the transient decoding data; and
according to the data type, updating at least one of a first bit in the plurality of first sub-data segments and a second bit in the plurality of second sub-data segments,
wherein the first bit is a kth bit in an ith sub-data segment of the plurality of first sub-data segments, and the second bit is a kth bit in an ith sub-data segment of the plurality of second sub-data segments.

18. The storage device according to claim 17, wherein if the data type is a first type, the updated first bit and the updated second bit comply with a first calculation logic, and
if the data type is a second type, then the updated first bit and the updated second bit comply with a second calculation logic,
wherein the first type is different from the second type, and the first calculation logic is different from the second calculation logic.

19. The storage device according to claim 17, wherein the operation of the memory controller executing the third type decoding operation based on the plurality of first sub-data segments and the plurality of second sub-data segments further comprises:
after updating the first bit, detecting a total number of error bits in the first data frame; and
if the total number of error bits in the first data frame does not decrease, restoring the first bit.

20. The storage device according to claim 11, wherein the first type decoding operation belongs to single frame decoding, and the second type decoding operation belongs to multi-frame decoding.
